(19) United States
(12) Patent Application Publication
(10) Pub. No.: US 2012/0314626 A1
(43) Pub. Date: Dec. 13, 2012

(54) CONCURRENT MULTI-BAND TRANSMITTER ARCHITECTURE

(75) Inventor: PERTTI ALAPURANEN, DELTONA, FL (US)

(73) Assignee: XG TECHNOLOGY, INC., SARASOTA, FL (US)

(21) Appl. No.: 13/428,473

(22) Filed: Mar. 23, 2012

Related U.S. Application Data
(60) Provisional application No. 61/494,492, filed on Jun. 8, 2011.

(51) Int. Cl. H04J 3/16

(52) U.S. Cl. 370/280

(57) ABSTRACT

This invention describes a hardware and software architecture for concurrent dual-band or multi-band operation. More specifically this invention describes a multi-band cognitive radio network that allows terminals to efficiently use signal processing and RF resources by synchronizing the framing in multiple frequency bands. The invention is useful in TDMA systems by allowing efficient use of signal processing resources.

### CROSS-REFERENCE TO RELATED APPLICATION

The present application claims the benefit of previously filed co-pending Provisional Patent Application Ser. No. 61/494,492 filed Jun. 8, 2011.

### FIELD OF THE INVENTION

This invention describes a hardware and software architecture for concurrent dual-band or multi-band operation. More specifically this invention describes a multi-band cognitive radio network that allows terminals to efficiently use signal processing and RF resources by synchronizing the framing in multiple frequency bands. The invention is useful in TDD systems by allowing efficient use of signal processing resources.

### BACKGROUND OF THE INVENTION

Modern cognitive radio technology allows dynamic spectrum sensing, spectrum management, mobility and spectrum sharing, to mention a few. Classical cognitive radios change frequency channels when interference levels or other parameters associated with operation can be improved by moving to another frequency. The modern signal processing and multiple antenna technologies, however, allow expanded cognitive operation where receiver algorithms and transmit waveforms are dynamically adjusted for the operational environment.

Radio spectrum is a limited resource. A large amount of spectrum is required to deliver services that are associated with modern wireless personal communications. Typical examples are smart phone Internet applications, wireless streaming audio, and video, to mention a few. These services consume a large amount of spectral resources causing both financial and spectrum policy issues.

Typically these services are provided using licensed spectrum. The financial burden from licensing can be defined as a cost of billions of dollars, even for a relatively small amount of spectrum, when compared to freely available unlicensed spectrum. The licensing, however, is required to make sure that current 1G to 4G radio technologies have the coordinated access they require to deliver a quality of service that is adequate for an end user application.

Currently in United States there are several hundred MHz of unlicensed spectrum that can be used for delivering wireless services to consumers, however, traditional radio technologies typically suffer from interference from uncoordinated access from other unlicensed users. A novel radio technology is required that can deliver service while being highly resistant to interference and creating as little interference as possible to other users in the unlicensed band.

A state of the art cognitive radio network can use multiple frequency bands concurrently. One of the issues, however, is how to efficiently use signal processing resources in these networks, more specifically how to allocate DSP resources to different bands when a large number of resources are required for operation on a single band. The issue is more severe in a portable terminal due to size, cost, and power consumption reasons.

### BRIEF SUMMARY OF THE INVENTION

This invention describes a hardware and software architecture for concurrent dual-band or multi-band operation. More specifically this invention describes processing method for a multi-band cognitive radio network that allows terminals to efficiently use signal processing and RF resources by synchronizing the framing in multiple frequency bands. The invention is useful in TDD (Time Division Duplex) systems by allowing efficient use of signal processing resources.

Therefore the objects of this invention include the following:

A Multi-band TDD system where uplink and downlink portions operating at different frequency bands, band A and band B, are synchronized so that when band A is operating uplink then the other frequency band B operates downlink.

A multi-band TDD system where the base station or the access point transmits downlink parts of a TDD framing so that they never coincide. This allows a device with a single receiver resource to receive 100% of the data.

A multi-band portable device where TDM resource sharing is prioritized so that band A gets all the resources it requires and band B gets resources that are not consumed by band A operation.

A multi-band portable device where TDD resource sharing is prioritized so that band A gets all the resources it requires except when important control resources have to be received in band B.

A multi-band TDD system where RX/TX switching times in multiple bands coincide in time. This allows resource switching from one band to another. For example, the receiver is switched from band A to band B while the transmitter is simultaneously switched from band B to band A.

A DSP processing system where receiver DSP resources are switched from one band to another in synchronized fashion relative to the TDD operation.

A joint scheduling of two frequency bands where the scheduler never schedules transmission to a single device so that it needs to use receiver resources for two or more bands at the same time.

A cognitive DSP processing system where receiver resources are assigned to multiple bands depending on conditions. For example a receiver algorithm A, B and C can be assigned all to a single band, or multi-band operation is allowed by using one or more resources that are assigned to a separate band.

For a fuller understanding of the nature and objects of the invention, reference should be made to the following detailed description taken in connection with the accompanying drawings.

### DESCRIPTION OF THE DRAWINGS

For a fuller understanding of the nature and objects of the invention, reference should be made to the accompanying drawings, in which:

FIG. 1 is a diagram showing transmitter and receiver resource use.

FIG. 2 is a diagram showing transmitter and receiver resource use.

### DETAILED DESCRIPTION OF THE INVENTION

In a multi-band radio network the bands are separated by tens or hundreds of MHZ, or even multiple GHz. For example, a lower band operating at 900 MHz can be independently operating with a 5.7 GHz upper band in the same portable terminal due to the large separation of frequencies. RF signals in these bands can be isolated using a simple diplexer design. However, in a typical design each band requires full signal processing and RF capability.

In a TDD system synchronization can help resource allocation in a cognitive radio network. A typical cognitive or advanced receiver uses many times more computational resources than the transmitter. The primary invention of this disclosure is the use of multi-band synchronization to allow optimal resource scheduling in a portable cognitive device. By synchronizing transmit and receive periods among multiple frequency bands the same resources, or less total resources, in a terminal can be used for simultaneous access to these bands.

The most beneficial resource use is when two bands (A and B) are synchronized so that when A is receiving, B is transmitting and vice versa, i.e. if A downlink is X% of a repeating frame then B uplink is the equivalent X%. The reason for this is that mobile device hardware resources, i.e. receiver and A/D converters plus receiver DSP resources can be maximally used, i.e. these resources are multiplexed in an exact fashion A, B, A, B. The same applies to the transmit resources.

Additionally, the use of RF bands can be prioritized so that DSP and hardware resources are allocated to band A first and only to band B if resources are available.

In a software defined radio DSP resources can be assigned sequentially between the two bands, and, as long as resource allocation does not overlap, only ½ of the physical resources of a typical multi-band capable system are required.

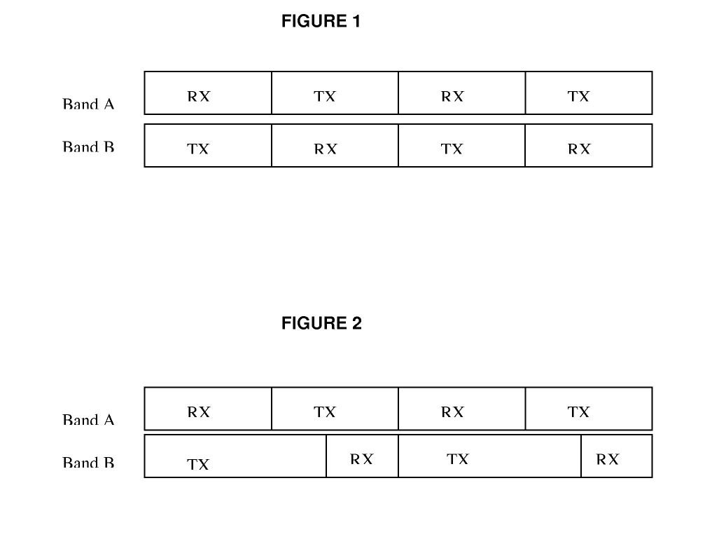

FIG. 1 shows a case where 100% of receiver resources and transmitter resources can be used. In reality, cognitive radio DSP receive operation consumes most signal processing resources and a multi-band joint scheduler is useful in the base station or access point. FIG. 2 shows a case where receiver is not scheduled 100% of the time at the mobile device while two transmit resources are required to transmit simultaneously on two bands.

Since certain changes may be made in the above described system and method for a concurrent multi-band transmitter architecture without departing from the scope of the invention herein involved, it is intended that all matter contained in the description thereof or shown in the accompanying figure shall be interpreted as illustrative and not in a limiting sense.

What is claimed is:

1) A method of operating a Multi-band Time Division Duplex cognitive radio system comprising using a frequency band A and a frequency band B operating at different frequencies then synchronizing transmission and reception such that frequency band A is operating an uplink frequency at the same time frequency band B is operating a downlink.

2) The method of operating a multi-band Time Division Duplex cognitive radio system of claim 1 further comprising Time Division Duplex framing such that said downlink part of frequency band A never coincides with said downlink part of frequency band B.

3) The method of operating a multi-band Time Division Duplex cognitive radio system of claim 1 further comprising prioritizing Time Division Duplex resource sharing so that frequency band A is using all the processing resources in a multi-band portable device required for operation and frequency band B is using processing resources in said multi-band portable device not consumed by frequency band A operation.

4) The method of operating a multi-band Time Division Duplex cognitive radio system of claim 1 further comprising prioritizing Time Division Duplex resource sharing so that frequency band A is using of all processing resources in a multi-band portable device required for operation except when important control processing resources in said multi-band portable device are being received in frequency band B operation.

5) The method of operating a multi-band Time Division Duplex cognitive radio system of claim 1 further comprising receiving and transmitting switching times in frequency band A and frequency band B coinciding in time.

6) The method of operating a multi-band Time Division Duplex cognitive radio system of claim 1 further comprising using a DSP processing system where receiver DSP resources are switched from frequency band A to frequency band B in synchronized fashion relative to the Time Division Duplex operation.

7) The method of operating a multi-band Time Division Duplex cognitive radio system of claim 1 further comprising joint scheduling of frequency band A and frequency band B wherein a transmission is never scheduled to a single multi-band portable device such that said multi-band portable device needs to use receiver resources for two or more bands at the same time.

8) The method of operating a multi-band Time Division Duplex cognitive radio system of claim 1 further comprising using a cognitive digital signal processing system wherein receiver resources are assigned to frequency band A or frequency band B depending on spectrum conditions.
